(19) United States
(12) Patent Application Publication
(10) Pub. No.: US 2014/0191611 A1
(43) Pub. Date: Jul. 10, 2014

(54) ROTOR CORE

(71) Applicant: Patrick Vohlgemuth, La Rochefoucauld (FR)

(72) Inventor: Patrick Vohlgemuth, La Rochefoucauld (FR)

(73) Assignee: MOTEURS LEROY-SOMER, Angouleme (FR)

(21) Appl. No.: 14/239,351

(22) PCT Filed: Aug. 1, 2012
(86) PCT No.: PCT/IB2012/053933

§ 371 Date: Feb. 18, 2014

(30) Foreign Application Priority Data
Aug. 30, 2011 (FR) 11 57638

(51) Int. Cl. H02K 1/24; H02K 15/02

(52) U.S. Cl. CPC H02K 1/24; H02K 15/022
USPC 310/216.004; 83/13

(57) ABSTRACT

The invention relates to a magnetic rotor core for an electric rotary machine, including a stack of magnetic laminations having some poles provided with pole tips, said core including a stack that comprises laminations of which at least one of the poles has at least one at least partially truncated pole tip, preferably a single pole tip.

The present invention relates to rotating electric machines, and more particularly the rotor yoke frames (also called rotor masses) formed by a stack of stacked magnetic plates.

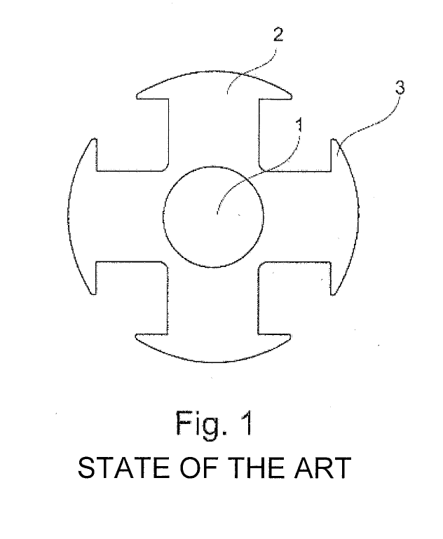

Conventionally, a 4-pole alternator rotary field magnetic plate has a symmetrical outline, being constructed, as illustrated in FIG. 1, around a shaft hole 1 centred on the axis of rotation of the rotor, around which are arranged four bodies 2 of orthogonal poles which conduct the magnetic flux towards the stator. At their end, these pole bodies are each laterally prolonged by two pole tips 3 which make it possible to spread the magnetic flux which will encompass the stator.

The rotary field magnetic plate is preferentially obtained by cutting from a steel sheet of small thickness (from a few tenths to a few millimetres). The plates are then stacked to form a rotor yoke frame of the desired length.

For the cutting, there are two possible options:
the rotor plate is cut from the centre of the stator plate, or
the rotor plate is cut independently of the stator plate.

Often, the choice of cutting according to the second option is made in order to maximize what can be termed the material yield, that is to say, the ratio between the material that is actually useful to the electrotechnical performance and the raw material consumed.

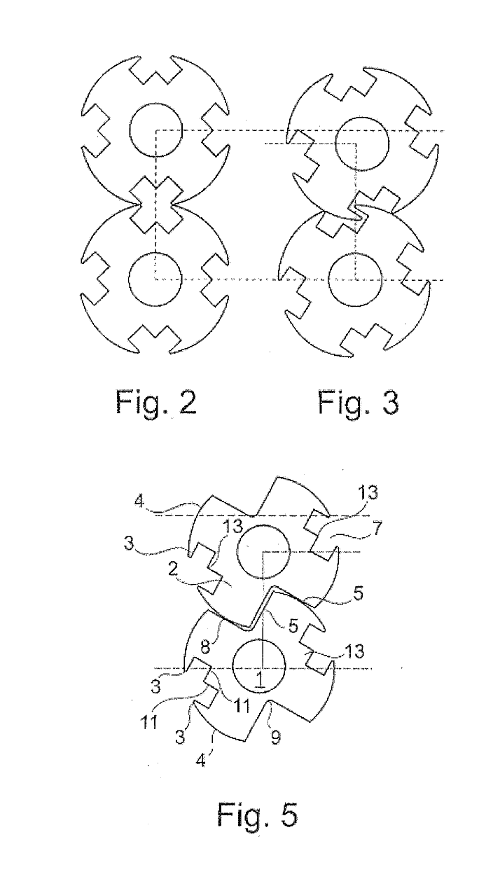

The conventional form of the rotor plate does not allow for a significant imbricating of its profile when cutting, as illustrated in FIGS. 2 and 3. This largely contributes to the generation of cutting waste, and consequently, the ratio explained above remains very much lower than 1.

The invention aims to limit the cutting waste without degrading the electrotechnical performance of the machine.

EP 0 863 600 discloses a miniature motor comprising a rotor having poles provided with a whole pole tip and a truncated pole tip.

The subject of the invention is thus a magnetic rotor yoke frame for rotating electric machine comprising a stack of magnetic plates having poles provided with pole tips, which is characterized in that the stack includes plates of which at least one of the poles has at least one pole tip at least partially truncated, a single pole tip being preferred.

The stack may thus comprise plates whose poles are each provided with one pole tip only. The pole tips of a pole associated with two consecutive poles are directed towards the same interpole space. Advantageously, all the poles of the plates of the stack are thus produced, with only one pole tip per pole, by preferentially observing an axial symmetry within each plate.

The stack preferably comprises plates of which the pole tips associated with one and the same pole are alternately situated on one side and the other of the pole, when moving along the yoke frame.

The stack may comprise identical plates arranged inverted or angularly offset, so that at least one pole of the yoke frame exhibits a succession of axially spaced pole tips, preferably one pole tip every other plate along a pole.

The yoke frame may comprise at least one plate having two adjacent poles each provided with a single pole tip, these two adjacent poles having their pole tips directed towards the same interpole space. Better, all the plates of the yoke frame are produced in this way.

The number of poles may be four or different from four.

Another subject of the invention is a method for cutting a magnetic sheet in order to produce the plates of a magnetic yoke frame, notably as defined hereinabove, in which the plates are cut from the sheet by imbricating at least two plates so that one pole of a plate is engaged in an interpole space of the other plate not having any pole tip.

Truncating, according to the invention, a part of the geometry of the rotor plate makes it possible to optimize its imbricating when cutting, and thus increase the material yield.

The proposed solution nevertheless makes it possible to reconstruct the conventional profile (observed along the axis of rotation) of the rotor in the rotor yoke frame plate stacking phase, and not to disproportionately affect the electrotechnical performance.

By virtue of the invention, it is possible to reduce the consumption of material needed for cutting the rotor and, in exemplary embodiments, the material saving may be as high as approximately 25%.

The pole tips are globally present over the length of the stack, for example at a ratio of one plate in every two as mentioned above. This makes it possible to retain, by virtue of the tips present, the mechanical function of maintaining the windings.

Regarding the electrotechnical functions of the tips, the fact that they are less numerous, because, for example, their presence is alternated every other plate along a pole of the yoke frame, reduces the magnetic conduction capacity of these regions. The iron density level nevertheless remains adequate to ensure a passage of the flux towards the stator. The desired polar spreading effect is therefore maintained. The reduction of the iron density in the tips also contributes to reducing the disturbing armature reaction effect from the stator to the rotor. These two effects combined mean that the performance of the magnetic circuit obtained in this way can ultimately be substantially better than a circuit which conventionally comprises complete tips. The result of this is that, with alternate tips, and all other things being equal from the stator point of view, the rotor's magnetizing current requirement is lower than with conventionally continuous pole tips along the yoke frame.

It can also be noted that this type of cutting and stacking markedly increases the exchange surface area between the rotor and the flow of air which circulates in the machine, with the attendant potential beneficial effects in terms of cooling of the rotor.

The invention can be better understood from reading the following detailed description of nonlimiting exemplary implementations thereof, and from studying the appended drawing, in which:

FIGS. 1 to 3, previously described, illustrate the prior art,

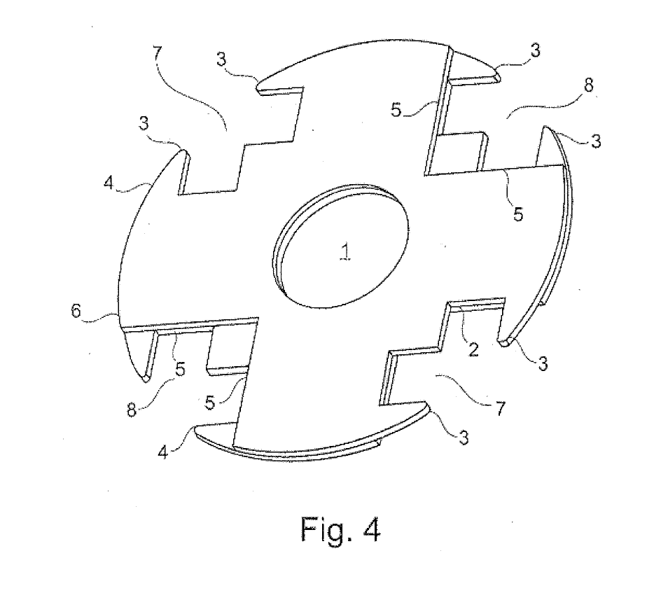

FIG. 4 represents an example of assembly of two rotor plates according to the invention,

FIG. 5 illustrates the possibility of imbricating the two plates when cutting the sheet,

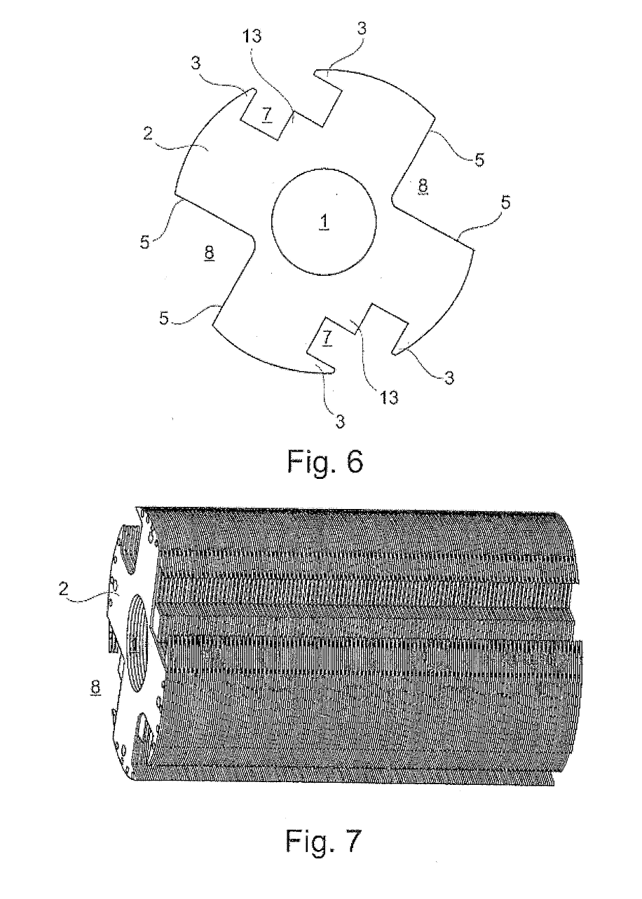

FIG. 6 represents, in isolation, a rotor plate according to the invention, and

FIG. 7 represents a rotor yoke frame according to the invention.

A rotor yoke frame according to the invention comprises, as illustrated in FIG. 7, a stack of assembled magnetic plates 4, one of which is represented in isolation in FIG. 4.

According to a preferred exemplary implementation of the invention, each plate 4 has poles which each have a single pole tip 3, the pole having, on the side opposite the pole tip 3, a rectilinear edge 5 which extends to the radially outer periphery 6 of the pole.

Two adjacent poles have their pole tips 3 directed towards one and the same interpole space 7 whereas the edges 5 without pole tips delimit another interpole space 8. One plate 4 has, in the example illustrated with four poles, two diametrically opposite interpole spaces 7 and two other interpole spaces 8, also diametrically opposite.

The rectilinear edges 5 meet in proximity to the hole 1 whereas, on the side where the pole tips 3 are present, the pole body widens to form a shoulder 11 serving as a support for a winding mounted on the yoke frame. The two consecutive shoulders 11 define an extension 13 which protrudes into the interpole space 7.

The absence of pole tip 3 allows for more imbricating when manufacturing the plates 4, as can be seen by a comparative study of FIGS. 3 and 5.

When cutting, the body 2 of a pole is engaged in the interpole space 8 without pole tips of the plate with which this pole body 2 is imbricated. There is thus a gain in compactness when cutting the plates from the sheet.

In the rotor yoke frame formed by the assembly of the plates, the presence of a pole tip 3 every other plate is observed along a pole of the yoke frame, which means that, globally, the yoke frame exhibits the same profile, when observed along its axis of rotation, as a conventional yoke frame. The extensions 13 alternate in the axial direction, just like the pole tips 3.

The invention is not limited to the example which has just been described. The invention extends to other polarities and to other types of rotating electric machines, motors or alternators.

The expression “comprising one” should be understood to be synonymous with “comprising at least one” unless specified otherwise.

1. Magnetic rotor yoke frame for rotating electric machine, comprising a stack of magnetic plates having poles provided with pole tips, the yoke frame being characterized in that the stack includes plates of which at least one of the poles has at least one pole tip at least partially truncated, a single pole tip being preferred,
the stack comprising plates of which the pole tips associated with one and the same pole are alternately situated on one side and on the other side of the pole.

2. Yoke frame according to claim 1, the stack comprising plates whose poles are each provided with only one pole tip.

3. Yoke frame according to claim 1, the stack comprising identical plates arranged inverted or angularly offset so that at least one pole presents, along the yoke frame, a succession of axially spaced pole tips.

4. Yoke frame according to claim 1, comprising a plate having two adjacent poles each provided with a single pole tip, these two adjacent poles having their pole tips directed towards the same interpole space.

5. Yoke frame according to claim 1, the number of poles being 4.

6. Method for cutting a magnetic sheet, especially in order to produce a magnetic yoke frame according to claim 1, in which the plates are cut from the sheet by imbricating at least two plates so that one pole of a plate is engaged in an interpole space of the other plate, this interpole space having no pole tip.

7. Magnetic plate suitable for the manufacture of a yoke frame according to claim 1, comprising two adjacent poles each provided with a single pole tip, the edges of these poles without pole tips delimiting an interpole space.

8. Plate according to claim 7, having two interpole spaces delimited by edges of poles without pole tips, the two interpole spaces being diametrically opposite.

9. Plate according to claim 8, having two interpole spaces delimited by edges of poles each having a pole tip, the two interpole spaces being diametrically opposite, extensions protruding into each of these interpole spaces to serve as a support for a winding arranged on the yoke frame.
